(19) United States
(12) Patent Application Publication
(10) Pub. No.: US 2003/0236852 A1
(43) Pub. Date: Dec. 25, 2003

(54) Sharing network adapter among multiple logical partitions in a data processing system

(75) Inventors: Lilian Sylvia Fernandes, Austin, TX (US); Vinit Jain, Austin, TX (US); Vasu Vallabhaneni, Austin, TX (US)

Correspondence Address: Joseph P. Lally, DEWAN & LALLY, L.L.P., P.O. Box 684749, Austin, TX, 78768-4749, US

(73) Assignee: International Business Machines Corporation, Armonk, NY (US)

(21) Appl. No.: 10/177,837

(22) Filed: Jun. 20, 2002

(51) Int. Cl. G06F 15/167

(52) U.S. Cl. 709/215

(57) ABSTRACT

A data processing system comprising a set of logical partitions and at least one hardware resource that is shared by two or more of the partitions is disclosed. The hardware resource is typically a network communication device such as a conventional network adapter. A first logical partition will generally take control or ownership of the resource through resource driver software that is part of the first partition. The other partitions that want to share the resource typically then register themselves with the first partition. In one embodiment, the registration of each subsequent partition is achieved by registering a set of low level network identifiers with the resource driver software. In one embodiment, a Media Access Control (MAC) address is assigned to each logical partition and the logical partition registers this address with the resource driver to identify itself from other logical partitions. The first partition will then typically configured the resource to prevent any hardware filtering of packets or other information that the resource might otherwise engage in. Once the hardware filtering is deactivated, the resource can receive and accept any and all packets on the connected medium. The driver software can then compare the destination MAC address against the list of registered MAC addresses and forward the packet to the appropriate LPAR if a match is detected. The driver can typically also accommodate broadcast packets that are intended to be delivered to every node on the network.

### BACKGROUND

1. Field of the Present Invention

The present invention generally relates to the field of data processing systems and more particularly to a data processing system employing multiple, logical partitions that share a common hardware element such as a network adapter.

2. History of Related Art

Logical partitioning refers to the ability to make a single multiprocessor system, such as an AS/400e system from IBM Corporation, behave as if it were two or more independent systems. A system implementing logical partitions (LPARs) may be referred to herein as an LPAR system. Logical partitions generally fall into two categories, namely, primary partitions and secondary partitions. Each logically partitioned system typically has a primary partition and one or more secondary partitions. Each logical partition represents a division of resources within the system. Each partition is referred to as “logical” because the division of resources is virtual, not physical. The primary resources in a typical system include its processors, main storage (system storage), I/O buses, and I/O adapters (IOA's). Each logical partition is configured to operate as an independent logical system, but each partition may share physical system attributes such as the system serial number, system model, and processor feature code. Other system attributes may vary among partitions. For example, each partition in a conventionally implemented LPAR has dedicated hardware such as processors, main storage, and I/O devices.

Logically partitioned systems are gaining in popularity as a means of extending an enterprise's computing capabilities without expending resources on additional hardware. Dedicating a portion of a system's resources (disk storage units, processors, memory, and I/O devices) to a partition achieves logical isolation of software. Logical partitions also have some hardware fault tolerance if configured properly. Interactive and batch workloads that may not run well together on a single machine can be isolated and run more efficiently in separate partitions. Similarly, production and test environments can be implemented on a single physical system. Thus, a customer can consolidate several systems into one system with logical partitions thereby eliminating the need for, and expense of, additional equipment.

Customers have increased the number of partitions they implement on their systems to the point of taxing the hardware constraints of the system. More specifically, because conventionally implemented LPAR systems contemplate dedicating certain hardware resources to a particular logical partition, the number of such resources must be increased when the number of partitions increases. Unfortunately, it is not typically desirable or even always possible to increase hardware resources in a system arbitrarily. The number of available expansion slots, for example, places a physical limitation on the number of resources such as network adapters that can be added to a system. Because most partitions require or strongly desire access to a network adapter, the number of partitions on a system may be undesirably limited by this hardware constraint. It would, therefore, be highly desirable to implement a system and method for enabling a multi-partitioned machine wherein each of the partitions has access to a common network adapter or a common set of network adapters such that the number of physical adapters is less than the number of logical partitions.

### SUMMARY OF THE INVENTION

The problems identified above are in large part addressed by a data processing system comprising a set of logical partitions and at least one hardware resource that is shared by two or more of the partitions. The hardware resource is typically a network communication device such as a conventional network adapter. A first logical partition will generally take control or ownership of the resource through resource driver software that is part of the first partition. The other partitions that want to share the resource typically then register themselves with the first partition. In one embodiment, the registration of each subsequent partition is achieved by registering a set of low level network identifiers with the resource driver software. In one embodiment, a Media Access Control (MAC) address is assigned to each logical partition. Each logical partition then registers this address with the resource driver to identify itself from other logical partitions. The first partition will then typically configured the resource to prevent any hardware filtering of packets or other information that the resource might otherwise engage in. Once the hardware filtering is deactivated, the resource can receive and accept any and all packets on the connected medium. The driver software can then compare the destination MAC address against the list of registered MAC addresses and forward the packet to the appropriate LPAR if a match is detected. The driver can typically also accommodate broadcast packets that are intended to be sent to every node on the network.

### BRIEF DESCRIPTION OF THE DRAWINGS

Other objects and advantages of the invention will become apparent upon reading the following detailed description and upon reference to the accompanying drawings in which:

FIG. 1 is a block diagram of a logically partitioned data processing system;

FIG. 2 is a block diagram of a logically partitioned data processing system including a shared hardware resource according to one embodiment of the present invention; and

FIG. 3 is a block diagram showing additional detail of the system of FIG. 2.

While the invention is susceptible to various modifications and alternative forms, specific embodiments thereof are shown by way of example in the drawings and will herein be described in detail. It should be understood, however, that the drawings and detailed description presented herein are not intended to limit the invention to the particular embodiment disclosed, but on the contrary, the intention is to cover all modifications, equivalents, and alternatives falling within the spirit and scope of the present invention as defined by the appended claims.

### DETAILED DESCRIPTION OF THE INVENTION

Generally speaking the present invention contemplates a system and method that enable the sharing of a hardware resource, such as a network adapter, among multiple partitions of a logically partitioned system. The hardware resource is typically “owned” by a primary or first partition. Each partition desiring use of the resource then shares the resource by creating a unique logical version of the resource. The unique logical versions are preferably transparent to the hardware resource itself thereby minimizing the impact of implementing the change.

Portions of the present invention may be implemented as a set of computer executable instructions stored on a computer readable medium. The medium may include a volatile medium such as the system memory or cache memory of a data processing system during times when the instructions are being executed by the system. At other times, the instructions may be stored on a non-volatile medium such as a floppy diskette, hard disk, CD ROM, DVD, flash memory card, and the like.

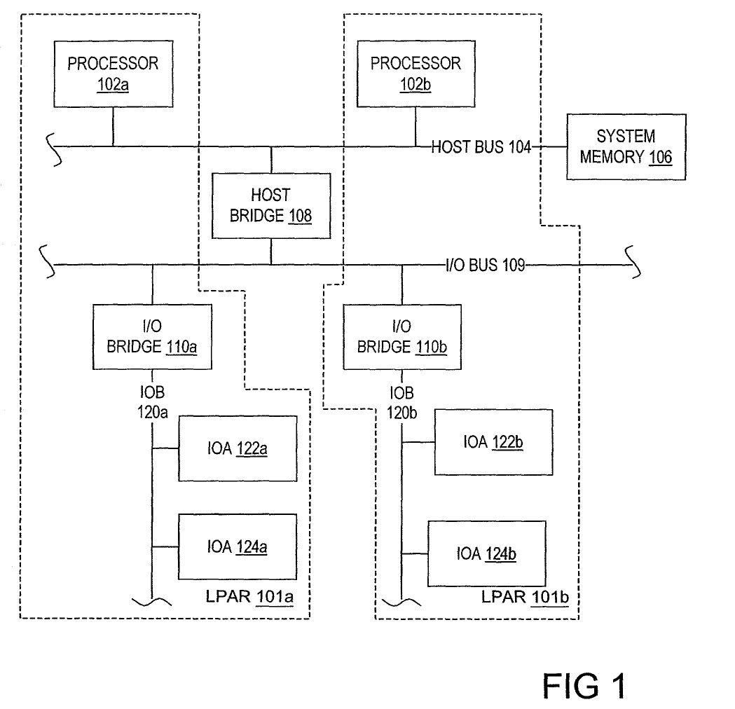

Before discussing novel elements of the invention, a brief introduction to logically partitioned data processing system is presented. Turning to the drawings, FIG. 1 is a block diagram of selected elements of a data processing system 100 employing a traditional logical partition scheme. In the depicted embodiment, system 100 includes multiple general purpose microprocessors including a first processor 102a and a second processor 102b (generically or collectively referred to as processor(s) 102). Processors 102 are connected to a system memory 106 via a host bus 104. System memory 106 is typically implemented with a high-density, volatile storage technology such as DRAM.

A host bridge 108 provides an interface between host bus 104 and an I/O bus 109. I/O bus 109 is representative of any standardized peripheral bus including as an example, a Peripheral Components Interface (PCI) bus well known in the field of microprocessor-based data processing system design. The depicted embodiment of system 100 uses I/O bus 109 as a “primary” I/O bus that is connected to first and second secondary I/O busses 120a and 120b through a pair of I/O bridges 110a and 110b. Attached to each I/O bus 120, are peripheral devices or I/O adapters (IOA's) identified by reference numerals 122a, 124a, 122b, and 124b. These peripheral devices may represent any of a variety of peripheral devices including as examples, graphics adapters, disk controllers, and network adapters.

System 100 is logically partitioned into a first or primary partition (LPAR) 101a and a secondary partition 101b. In the partitioning depicted in FIG. 1, system resources such as processors 102, I/O busses 120, and IOA's 122 are dedicated to either first LPAR 101a or second LPAR 101b. Dedicating system resources to a particular partition is typical of conventionally implemented logically partitioned systems. The depicted system includes just two partitions so that dedicating resources per partition can be achieved within the constraints of the system. More specifically, system 100 will typically include sufficient I/O slots to accommodate two partitions, each having its own dedicated IOA's. If the number of partitions is increased, however, the number of IOA slots on the system may impose a substantial and undesirable limitation on the number of IOA's that can be dedicated to each slot.

Among the most commonly used IOA is the network communication device or network adapter that the system uses to communicate with a network to which other data processing systems are also attached. Network adapters enable systems to communicate via local area networks and/or wide area networks such as the Internet. Because most if not all logical partitions in any data processing system can benefit from access to a network, each partition typically requires access to a network adapter. If the system has three or more partitions, outfitting each partition with a dedicated network adapter will quickly consume all of the available IOA slots.

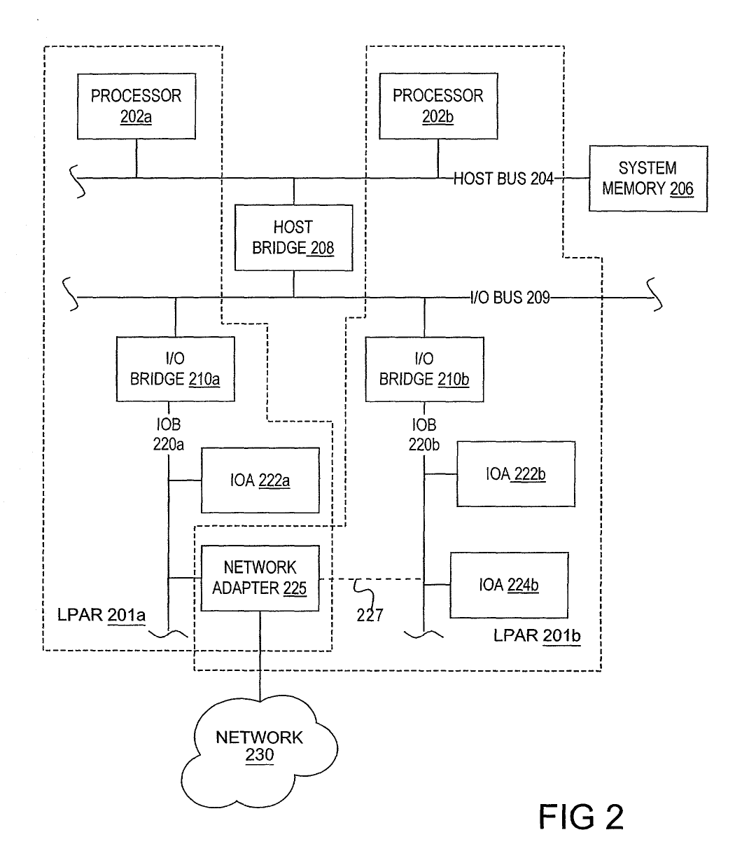

To address the problem of limited resources in a highly partitioned system, the present invention contemplates the sharing of one or more resources among the logical partitions. Turning to FIG. 2, a block diagram of selected elements of a data processing system 200 according to one embodiment of the present invention is depicted. In the depicted embodiment, system 200 includes substantially similar system resources as system 100 described with respect to FIG. 1 above. Thus, system 200 includes a set of processors 200a through 200n (processor(s) 200) connected, through a host bus 204, to system memory 206. A host bridge 208 connects host bus 204 with a primary I/O bus 209. I/O bridges 210a and 210b provide corresponding I/O busses 220a and 220b. First I/O bus 220a connects to a generic peripheral device 222a and a network adapter 225. Second I/O bus 220b connects to generic peripheral device 222b and 224b. No network adapter is connected to second I/O bus 220b.

System 200 is logically partitioned into a first LPAR 201a and a second LPAR 201b. Importantly, the logical partitions 201 of system 200 share a system resource in the form of network adapter 225 such that both partitions have access to a network identified by reference numeral 230 via a common adapter. More generally, system 200 may include many partitions and multiple network adapters, but at least one of the adapters is shared in common by two or more of the partitions.

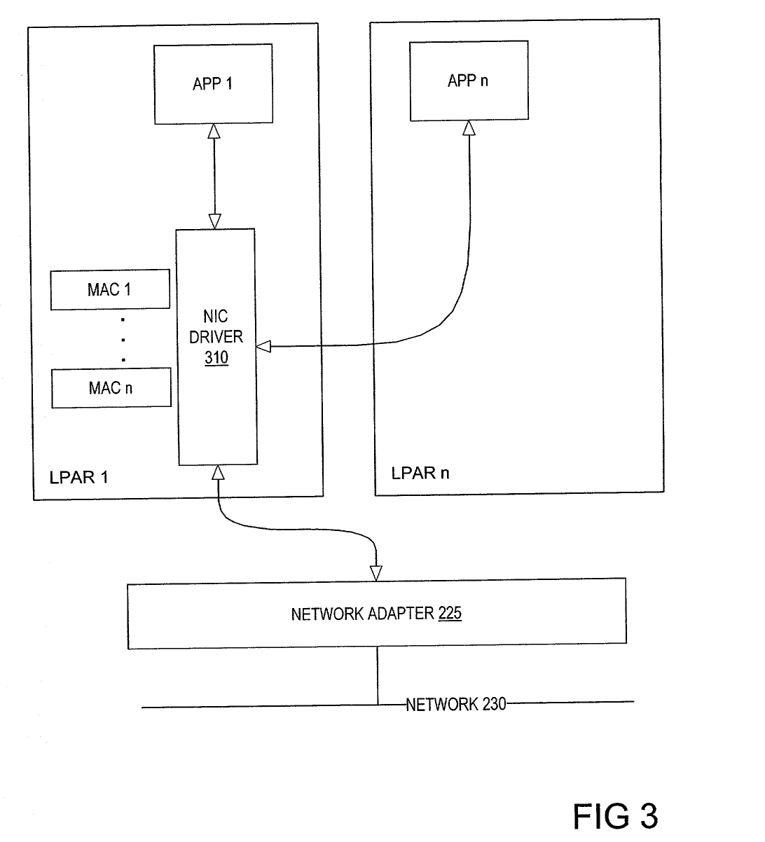

Turning now to FIG. 3, a block diagram of selected elements of a logically partitioned system 200 is presented to emphasize shared resource features of the present invention. In the depicted embodiment, system 200 includes a shared resource in the form of network adapter 225 and an arbitrary number of partitions represented by LPAR 1 through LPAR n. Typically, a primary partition initially takes control of the resource to be shared. As depicted in FIG. 3, LPAR 1 assumes ownership and control of network adapter 225 via driver code identified as NIC driver 310.

After assuming control of the shared resource, the owning partition then configures the resource to recognize and accept all traffic on network 225. In the specific case of a network adapter, LPAR 1 achieves this state by configuring the adapter in a “promiscuous” mode in which network adapter 225 does no filtering of network data packets based upon the destination address of those packets. When operating in promiscuous mode, network adapter 225 receives each data packet traveling over network 230. In the context of the present invention, promiscuous mode enables system 200 to accept data packets that are destined for any of its logical partitions. Appropriate filtering and routing of the received packets can then be performed by driver 310.

Each logical partition that wants to share network adapter 225 with LPAR 1 “registers” itself with LPAR 1. In one embodiment, this registration process is accomplished by requiring each partition to send LPAR 1 and NIC driver 310 a unique identifier. Driver 310 then uses the identifiers to filter and route packets received by adapter 225.

In an embodiment that emphasizes compatibility with existing network protocols, each LPAR that wants to share driver 225 sends driver 310 a low-level identifier. For purposes of this disclosure, a low-level identifier refers to an identifier embedded below the network layer of the protocol. (See the Open System Interconnect (OSI) reference model for a description of the seven layers of a prototypical network communication protocol). In an Ethernet network environment, for example, media access control (MAC) addresses provide these low-level identifiers.

Each LPAR in system 200 is typically assigned or otherwise associated with a unique MAC address. The LPAR is then responsible for providing its MAC address to LPAR 1 and NIC driver 310. Thus, FIG. 3 illustrates a stack of MAC addresses that are registered with NIC driver 310. In one embodiment, the communication of information among the LPARs of system 200 is facilitated by IP compatible, low-latency inter-partition communication modules. These communication modules enable fast access among the various partitions of a single physical system. The inter-partition communication module typically creates a virtual IP network comprising the various partitions that enables partitions to communicate with each other without utilizing the system's I/O subsystem. An example of such a module is the HiperSocket™ inter partition module comprising a portion of the z/OS operating system from IBM Corporation. This inter-partition communication is also leveraged when the various LPAR's transmit and receive packets over the network.

Once network adapter 225 is configured in promiscuous mode and one or more LPARs have registered their MAC addresses or other identifiers with LPAR 1 and, more specifically with NIC driver 310, all data packets traversing network 230 will be received and accepted by adapter 225. NIC driver 310 will then perform software filtering and routing of each packet based upon its MAC address. If the MAC address indicates that the corresponding packet was sent as a broadcast packet intended to be received by each node on the system, NIC driver 310 will forward the packet to each registered LPAR typically via the inter-LPAR communication facility. If the packet has a specific (non-broadcast) MAC address, NIC driver 310 compares the MAC address against all of its registered MAC addresses. If NIC driver 310 detects a match between a packet's MAC address and a MAC address currently registered with NIC driver 310, the driver forwards the packet to the appropriate LPAR. If the packet MAC address of a received packet does not match a MAC address registered with NIC driver 310, the packet is discarded. When a participating LPAR wants to send a packet to a remote node (a network node external to system 200), the LPAR forwards the packet to NIC driver 310 via the inter-partition facility. NIC driver 310 is then responsible for sending the packet to the network. If a first LPAR forwards a packet to NIC driver 310 that contains the MAC address of a second LPAR within the system, NIC driver 310 is configured to forward the packet to the second LPAR without placing the packet on network 230. Thus, the destination address of each packet received by NIC driver 310, whether originating from an LPAR of system 200 or from network 230, is compared against the MAC addresses registered with the driver.

The use of low level identifiers to differentiate among the various logical partitions enable the present invention to be implemented relatively transparently to the bulk of the existing network protocols. Substantially all of necessary modifications can be implemented at the MAC layer thereby leaving the bulk of the protocol stack as it existed previously. This feature of the invention beneficially minimizes the impact of the invention on the existing network and eases the implementation.

It will be apparent to those skilled in the art having the benefit of this disclosure that the present invention contemplates a logically partitioned data processing system enabled to share a hardware resource such as a network interface card to reduce demand for limited available adapter slots. It is understood that the form of the invention shown and described in the detailed description and the drawings are to be taken merely as presently preferred examples. It is intended that the following claims be interpreted broadly to embrace all the variations of the preferred embodiments disclosed.

What is claimed is:

1. A data processing system, comprising:
a set of hardware resources;
means for organizing the set of hardware resources into first and second logical partitions, wherein resources within a partition are logically dedicated to the partition;
a shareable resource;
driver means suitable for enabling the first logical partition to control the shareable resource;
inter-partition means suitable for enabling the first and second partitions to communicate with each other;
means for enabling the second partition to register an identifier with the driver means; and
wherein the driver means is suitable for comparing the destination address of a received data packet to the registered identifier, and further suitable for forwarding the packet to the second partition responsive to matching the destination packet with the hardware identifier.

2. The system of claim 1, wherein the shareable resource comprises a network adapter suitable for connecting the system to a network.

3. The system of claim 2, wherein the driver means includes means for enabling the first partition to disable filtering network packets by the network adapter.

4. The system of claim 1, wherein each identifier comprises a media access control address of the corresponding partition.

5. The system of claim 1, wherein the driver means is further configured to forward a received packet to each of a set of registered partitions responsive to determining that the packet contains a broadcast destination address.

6. The system of claim 1, wherein the driver means is configured to forward a packet received from the second partition to a third partition via the inter-partition code means responsive to determining the destination address matches the identifiers of a third partition registered with the driver means.

7. The system of claim 1, wherein the inter-partition means is configured to enable the first and second partitions to communicate directly without accessing an I/O subsystem of the system.

8. A computer program product comprising computer executable instructions on a computer readable medium for enabling resource sharing in a multiple partition data processing system, comprising:
computer code means for organizing a set of hardware resources into first and second logical partitions, wherein resources within a partition are logically dedicated to the partition;
driver code means suitable for enabling the first logical partition to control a shareable resource;
inter-partition code means suitable for enabling the first and second partitions to communicate with each other;
computer code means for enabling the second partition to register an identifier with the driver means; and
wherein the driver means is suitable for comparing the destination address of a received data packet to the registered identifier, and further suitable for forwarding the packet to the second partition responsive to matching the destination packet with the hardware identifier.

9. The computer program product of claim 8, wherein the shareable resource comprises a network adapter suitable for connecting the system to a network.

10. The computer program product of claim 9, wherein the driver means includes means for enabling the first partition to disable filtering network packets by the network adapter.

11. The computer program product of claim 8, wherein each identifier comprises a media access control address of the corresponding partition.

12. The computer program product of claim 8, wherein the driver means is further configured to forward a received packet to each of a set of registered partitions responsive to determining that the packet contains a broadcast destination address.

13. The computer program product of claim 8, wherein the driver means is configured to forward a packet received from the second partition to a third partition via the inter-partition code means responsive to determining the destination address matches the identifiers of a third partition registered with the driver means.

14. The computer program product of claim 8, wherein the inter-partition means is configured to enable the first and second partitions to communicate directly without accessing an I/O subsystem of the system.

15. A method for enabling resource sharing in a multiple partition data processing system, comprising:
organizing a set of hardware resources into first and second logical partitions, wherein resources within a partition are logically dedicated to the partition;
enabling the first logical partition to control a shareable resource;
enabling the first and second partitions to communicate with each other;
registering an identifier corresponding to the second partition with the driver means; and
wherein the driver means is suitable for comparing the destination address of a received data packet to the registered identifier, and further suitable for forwarding the packet to the second partition responsive to matching the destination packet with the hardware identifier.

16. The method of claim 15, wherein the shareable resource comprises a network adapter suitable for connecting the system to a network.

17. The method of claim 16, wherein the driver means includes means for enabling the first partition to disable filtering network packets by the network adapter.

18. The method of claim 15, wherein each identifier comprises a media access control address of the corresponding partition.

19. The method of claim 15, wherein the driver means is further configured to forward a received packet to each of a set of registered partitions responsive to determining that the packet contains a broadcast destination address.

20. The method of claim 15, wherein the driver means is configured to forward a packet received from the second partition to a third partition via the inter-partition code means responsive to determining the destination address matches the identifiers of a third partition registered with the driver means.

21. The method of claim 15, wherein the inter-partition means is configured to enable the first and second partitions to communicate directly without accessing an I/O subsystem of the system.
